(19) United States
(12) Patent Application Publication
(10) Pub. No.: US 2002/0039718 A1
(43) Pub. Date: Apr. 4, 2002

(54) Dental implant system and additional methods of attachment

(75) Inventor: Norman Ho-Kwong Kwan, Mississauga (CA)

Correspondence Address: OPPENHEIMER WOLFF & DONNELLY LLP, 840 NEWPORT CENTER DRIVE, SUITE 700, NEWPORT BEACH, CA, 92660, US

(73) Assignee: BioHex Corporation

(21) Appl. No.: 09/967,556

(22) Filed: Sep. 28, 2001

Related U.S. Application Data
(60) Provisional application No. 60/236,518, filed on Sep. 29, 2000.
(60) Provisional application No. 60/237,222, filed on Oct. 2, 2000.

(51) Int. Cl. A61C 8/00

(52) U.S. Cl. 433/173; 433/172

(57) ABSTRACT

A dental implant system and additional methods of attachment are disclosed. The dental implant system includes an implant-abutment device, healing ball, analog abutment, retaining screw and guide pin. The universality of the system significantly reduces the number of surgical and prosthetic interventions and overall time of completion associated with the methods of attachment. As such, the device and procedures are simple, predictable and highly effective. Further, operative risks, pain, and infections are reduced, thereby improving patient recovery time and quality of life.

### CROSS REFERENCE TO RELATED APPLICATIONS

The present application claims priority of U.S. Provisional Application Serial no. 60/236,518, filed Sep. 29, 2000, and U.S. Provisional Application Serial No. 60/237,222, filed Oct. 2, 2000, whose contents are fully incorporated herein by reference.

### BACKGROUND OF THE INVENTION

Dental implants have been known and used since at least the 1930's; see, e.g., U.S. Pat. No. 5,312,254 of Joel L. Rosenlicht. See also U.S. Pat. No. 5,145,371 of Lars Jorneus which discusses the osseointegration method of integrating a dental implant into a patient's jaw. The disclosure of each of these patents is hereby incorporated by reference into this specification.

A wide variety of dental implant styles and systems are currently available. For example, dental implants having cutting means are also known in the art, as disclosed in U.S. Pat. No. 5,338,197, the disclosure of which is hereby incorporated by reference into this specification. Another type of dental implant assembly is one that uses a hexagonal abutment implant system. This assembly is disclosed in U.S. Pat. No. 5,564,924, of which the disclosure is also herein incorporated by reference.

In general, dental implants are moderately expensive, ranging in cost from approximately two to four hundred dollars (excluding laboratory costs). However, the labor associated with the implant procedure often costs eight to twenty times the amount of the implant itself, ranging from about three to four thousand dollars per tooth. One of the reasons for this substantial cost is the multiplicity of steps required by the implant procedure. An example of these prior art steps will be described below with reference to Nobelpharma catalog PRI 385 94.03 2nd edition (published by the Nobelpharma AB, Box 5190, S-402 26 Goteborg, Sweden).

In the first step of the prior art procedure, an implant or “fixture” is purchased; see, e.g., page 7 of the Nobelpharma catalog and the reference to the 3.75 mm and 4.0 mm titanium fixtures illustrated on such page. The fixture so purchased must then be placed into an “instrument set for fixture placement,” which is shown on page 22 of the Nobelpharma catalog.

Once the fixture is disposed in the “instrument set . . . , ” a “fixture mount” is then attached to the fixture by means of a wrench and a screwdriver. The “fixture mount” devices are shown on page 22 of the Nobelpharma catalog. The instruments for fixture placement of the fixture are also shown on page 22 of the Nobelpharma catalog (see wrench part 17 and screwdriver part 19).

Next, a “connection to contra-angle handpiece” (see part 11 on page 22 of the Nobelpharma catalog) is attached to a handpiece (see page 31 of the Nobelpharma catalog) and the implant assembly is then driven into the jawbone of a patient.

Thereafter, the fixture mount is removed from the fixture and a cover screw (see page 9 of the Nobelpharma catalog) is inserted into the fixture. Next, the surgical site is allowed to heal for about three to about six months. See, e.g., Branemark/Zarb/Alberektsson: “Tissue Integrated Prostheses” (Quintessence Books, 1985).

After the healing period, the implant is exposed by surgical procedures and the cover screw is removed. A healing abutment (see page 39 of the Nobelpharma catalog) is then attached to the fixture. In general, the healing abutment is left in place for approximately two to three weeks, depending upon how the patient's tissue has healed.

Thereafter, the healing abutment is removed and an implant abutment is attached to the fixture. The type of implant abutment used will depend on the requirements of the patient. Thus, for example, referring to pages 38 and 39 of the Nobelpharma catalog, one may use a standard abutment, an “EsthetiCone®” abutment, a “CeraOne®” abutment, a “Ball Attachment,” an Angulated Abutment,” and other standard and/or proprietary abutments.

Next, the desired prosthesis is formulated by conventional means and adjusted to fit within the patient's mouth. For a single-tooth prosthesis, generally one to two impressions are made to capture the size and shape of the abutment to the tooth. Multiple mock-ups and adjustments are often made before the final prosthesis is finally secured to the implant.

For a multiple-tooth prosthesis, the course of treatment is not always predictable; multiple impressions and frameworks need to be created involving multiple appointments. Typically, the entire treatment, including initial implant placement and second stage surgery, would span a period of time ranging from approximately nine to eighteen months, or longer, before the final prosthesis is secured within the patient's mouth.

In addition to the increased time, labor and costs, various theoretical and practical implications need to be considered for multiple tooth or full-mouth reconstruction. In multiple restorations, “draw,” “common path of insertion,” “parallel,” “passivity” and “stability” are terms that describe the most critical objectives of such a procedure.

Draw is perhaps best described as the effects of friction, but not binding. Multiple implants and their abutments are rarely, if ever, perfectly aligned within the patient's mouth. Traditional methods of multiple tooth restoration require the heads/abutments and prostheses to be modified or made parallel until a common path of insertion is achieved and until the prosthesis is passive with respect to all of the abutments and soft tissue. In other words, it must be possible to place the prosthesis in position by moving the structure onto the abutments in a straight line (i.e., the common path of insertion), with sufficient friction or draw to ensure a firm fit. Once in place, the prosthesis must be passive, which means it must fit the abutments and the soft tissue profile such that there is no undue tension and no motion can take place.

It will be apparent that these prior art procedures require a myriad number of instruments and parts, typically two surgical procedures, many trips by the patient to the dentist, increased treatment times and prolonged healing periods resulting in an overall reduced quality of life for the patient. Further, an expensive, time consuming and labor intensive “trial and error” system is crucial to such procedures because each prosthesis is custom made to the particular shape, design, location and quantity of abutments for each patient. Therefore, not only are the processes tedious and expensive, but, also, each surgical procedure introduces a certain element of risk, pain, and suffering.

In view of the above, there is a need for a dental implant system and associated methods of attachment that are simple, predictable and effective. In particular, it is desirable that the dental implant system and attachment methods include universal, interchangeable components, reduce post-operative infection, improve device/prosthesis strength and prolong its stability, and reduce the overall time for reconstruction procedures. It is also desirable that the dental implant system and associated methods enable a practitioner to form a final prosthesis, including an infinite number of facsimiles of said final prosthesis, based on a single impression.

### BRIEF SUMMARY OF THE INVENTION

In general, the present invention contemplates a method of dental reconstruction comprising inserting one or more devices into an edentulous space within a patient's mouth, wherein each of the devices includes a head portion. The method further includes placing a healing ball on each of the heads of the devices and forming a dental impression with impression material, wherein the healing balls transfer with the impression material upon removal from a patient's mouth. In addition, the method includes mounting an analog-abutment within each of the healing balls of the impression, forming a final model of the dental impression including the analog abutments, wherein the final model replicates the patient's edentulous space and creating a final prosthesis using the final model. Lastly, the method includes installing the final prosthesis within the edentulous space of the patient.

The present invention also contemplate a universal dental implant system comprising a head portion and a base portion, wherein the base portion includes fastening elements to secure the implant within a jawbone of a patient. The system further includes a healing ball, wherein the healing ball mounts onto the head portion. In addition, the system further includes a retaining screw or guide pin that secures the healing ball onto the head portion.

In addition, the present invention also contemplates a method of forming a dental prosthetic comprising fixing a stud element in a predetermined site, placing a removable protective element on the stud element and forming a first impression over the protective element at the predetermined site. The method also includes removing the protective element from the stud element with the first impression, mounting an abutment in the protective element contained in the first impression, forming a second impression over the abutment such that the second impression substantially replicates the predetermined site, and creating a prosthesis by relying on information provided by the second impression.

The present invention also contemplates a method of forming a dental prosthetic comprising providing a first impression which replicates a dental site, inserting a fixation element into the first impression, providing a second impression which replicates the dental site and retains the fixation element and modifying the fixation element on the second impression as needed so as to provide sufficient information to create the prosthetic.

In addition, the present invention also contemplates a model for creating a dental prosthetic comprising a form replicating the region of an edentulous space within a patient's mouth, the form having an analog abutment protruding from the region, and the analog abutment having a modification created to ensure insertability and removability of a prosthetic within a patient's mouth.

### BRIEF DESCRIPTION OF THE DRAWINGS

Other features and advantages of the present invention will be seen as the following description of particular embodiments progresses in conjunction with the drawings, in which:

FIG. 1A illustrates one embodiment of a one-piece universal implant-abutment device in accordance with the present invention;

FIG. 1B is a top-view of the device of FIG. 1A in accordance with the present invention;

FIG. 2 is another embodiment of a one-piece universal implant-abutment device in accordance with the present invention;

FIG. 3 is a sectional view of the device of FIG. 1A in accordance with the present invention;

FIG. 4 illustrates one embodiment of a healing ball of the dental implant system in accordance with the present invention;

FIG. 5 illustrates another embodiment of a healing ball of the dental implant system in accordance with the present invention;

FIG. 6A is a perspective view of one embodiment of a dental implant system of the present invention as inserted within the jawbone of a patient in accordance with the present invention;

FIG. 6B is a perspective view of another embodiment of a dental implant system of the present invention as inserted within the jawbone of a patient in accordance with the present invention;

FIG. 7 illustrates one embodiment of an analog-abutment of the dental implant system in accordance with the present invention;

FIG. 8 illustrates one embodiment of a retaining screw of the dental implant system in accordance with the present invention;

FIG. 9 illustrates one embodiment of a guide pin of the dental implant system in accordance with the present invention;

FIG. 10 illustrates one embodiment of an incision formed as part of the methods of attachment of the dental implant system in accordance with the present invention;

FIG. 11 illustrates one embodiment of a tissue flap formed as part of the methods of attachment of the dental implant system in accordance with the present invention;

FIG. 12 illustrates one embodiment of a hole formed as part of the methods of attachment of the dental implant system in accordance with the present invention;

FIG. 13 illustrates one embodiment of a implant-abutment device inserted within the hole of FIG. 12 as part of the methods of attachment of the dental implant system in accordance with the present invention;

FIG. 14 illustrates one embodiment of a healing ball seated on the device of FIG. 13 as part of the methods of attachment of the dental implant system in accordance with the present invention;

FIG. 15 illustrates one embodiment of an impression tray used as part of the methods of attachment of the dental implant system in accordance with the present invention;

FIG. 16 illustrates one embodiment of an impression formed as part of the methods of attachment of the dental implant system in accordance with the present invention;

FIG. 17 illustrates one embodiment of an analog-abutment inserted within the impression of FIG. 16 in accordance with the present invention;

FIG. 18 illustrates one embodiment of a model formed as part of the methods of attachment of the dental implant system in accordance with the present invention;

FIG. 19 illustrates one embodiment of a prosthesis formed as part of the methods of attachment of the dental implant system in accordance with the present invention;

FIG. 20 illustrates one embodiment of multiple implant-abutment devices inserted within the jawbone of a patient as part of the methods of attachment of the dental implant system in accordance with the present invention;

FIG. 21 illustrates another embodiment of an impression tray used as part of the methods of attachment of the dental implant system in accordance with the present invention;

FIG. 22 illustrates one embodiment of an alignment of multiple implant-abutment devices of the dental implant system in accordance with the present invention;

FIG. 23 illustrates one embodiment of multiple implant-abutment devices modified as part of the methods of attachment of the dental implant system in accordance with the present invention;

FIG. 24 illustrates another embodiment of multiple implant-abutment devices modified as part of the methods of attachment of the dental implant system in accordance with the present invention;

FIG. 25 illustrates another embodiment of a modified implant-abutment device in accordance with the present invention;

FIG. 26 illustrates one embodiment of a section of a template of the dental implant system in accordance with the present invention; and

FIG. 27 illustrates one embodiment of a section of a template positioned on an implant-abutment device in accordance with the present invention.

### DETAILED DESCRIPTION OF THE INVENTION

Disclosed herein is a detailed description of various illustrated embodiments of the invention. This description is not to be taken in a limiting sense, but is made merely for the purpose of illustrating the general principles of the invention. The section titles and overall organization of the present detailed description are for the purpose of convenience only and are not intended to limit the present invention.

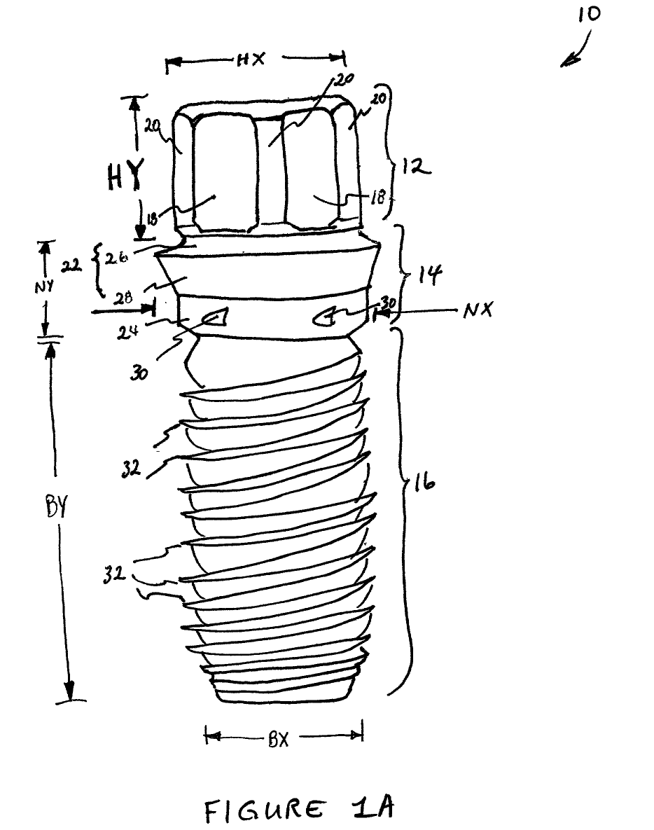

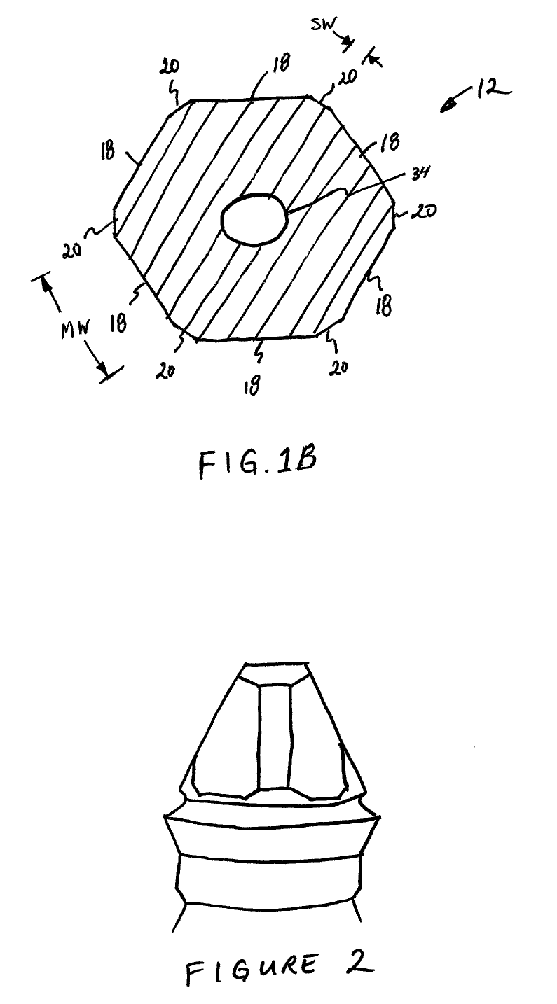

Referring to FIG. 1A, an embodiment of a dental implant system in accordance with the present invention includes a one-piece universal implant-abutment device 10. In general, the universal implant-abutment 10 is a single-piece device 10 including head 12, neck 14 and base 16 sections. It should be noted that the device 10 referred to throughout this description is a single-piece component. However, it is understood that the disclosure of the present invention may also apply to devices including one or more elements. Further, the universal implant system of the present invention may be used to treat both humans and animals alike.

The implant-abutment device 10 shown in FIG. 1A is made of titanium or titanium alloy. Alternatively, the device 10 may be made of one or more other materials including, but not limited to, metals and/or metal alloys, such as gold, silver, palladium, vanadium, cobalt alloy, stainless steel and the like, plastics, ceramics, and materials disclosed in U.S. Pat. No. 6,068,479, U.S. Pat. No. 5,373,621, U.S. Pat. No. 5,372,660, U.S. Pat. No. 5,358,529, U.S. Pat. No. 5,354,390, U.S. Pat. No. 5,334,264, U.S. Pat. No. 5,326,362, U.S. Pat. No. 5,205,921, and U.S. Pat. No. 5,191,323, the disclosures of which are hereby incorporated by reference into this specification. The device material should be biocompatible, non-toxic (e.g., medical grade) and provide sufficient strength and structural integrity when implanted within the jawbone of a patient.

The height HY and diameter HX of the head 12 of the implant-abutment device 10 are approximately within the range of 1.0 mm to 8.0 mm and 1.0 mm to 12.0 mm, respectively. In one embodiment of the invention, the height HY and diameter HX of the head are approximately 3.0 mm and 3.8 mm, respectively. The associated height NY and diameter NX of the neck 14 of the implant-abutment device 10 are approximately within the range of 0 mm to 8.0 mm and 1.0 mm to 12.0 mm, respectively. In addition, the height BY and diameter BX of the base 16 of the device 10 are within the range of approximately 6.0 mm to 30.0 mm and 1.0 mm to 12.0 mm, respectively. Alternative heights and diameters can also be used provided that the overall device dimensions permit proper implantation and functioning of the device 10.

As shown in FIGS. 1A and 1B, the perimeter of the head 12 is substantially in the shape of a hexagon and includes six, planar, external main-walls 18. In one embodiment, the six, planar main-walls 18 are interconnected by six, substantially planar, external side-walls 20. In general, the width MW of each main-wall 18 is approximately within the range of 1.0 mm to 12.0 mm and the width SW of each side-wall 20 is approximately within the range of 0 mm to 12.0 mm.

In another embodiment of the invention, the head configuration includes substantially planar main-walls 18 and non-planar (e.g., arcuate) side-walls 20, thereby producing improved comfort and reduced irritation within the patient's mouth. Alternatively, the main walls 18 may be substantially non-planar and the side walls 20 planar, or both the main walls 18 and side walls may be substantially non-planar.

In an alternate embodiment, shown in FIG. 2, the walls 18,20 of the head 12 are tapered. The walls 18,20, or portions thereof, may taper in either a radially inward or outward direction. Other configurations of the head 12 including, but not limited to, cylindrical, triangular, square, and octagonal-shaped are also included within the scope of the claimed invention. Additional shapes, such as those disclosed in U.S. Pat. No. 6,068,479, of which the entire disclosure is incorporated by reference herein, may also be used for the head 12 of the present invention. For brevity and reader convenience, the hexagonal head configuration will be used for illustration and not limitation throughout this specification.

Referring to FIG. 1A, the neck 14 of the universal implant-abutment device 10 includes a ridge 22 and pedestal 24. The ring-shaped ridge 22 includes an upper portion or ledge 26 that slopes in a radially outward direction from the lower portion of the head 12. In general, the ridge 22 may be any polygonal shape that provides sufficient support to function as a stop and/or border for a variety of components that either permanently or temporarily attach to the head 12 of the device 10. These components and their methods of attachment are described in further detail below.

The lower portion 28 of the ridge 22 slightly tapers in a radially inward direction. Further, the lower portion 28 provides additional strength and structural integrity to the neck 14 to withstand the various forces exerted upon it during and after the implant procedure.

As with the head 12, the various elements or portions of the neck 14, either alone or in combination, may also be a variety of shapes or configurations, including, but not limited to, cylindrical, tapered-cylindrical, stepped, arcuate, chamfered, hexagonal, polygonal and other shapes, including combinations thereof.

Adjacent to and beneath the ridge 22 is the pedestal 24. The pedestal 24, similar to the lower portion 28 of the ridge 22, provides additional structural strength to the device 10. In one embodiment of the invention, the pedestal 24 may include one or more notches 30. As shown in FIG. 1A, the notches 30 are formed around the perimeter of the pedestal 24 and are configured to function as cutting elements. Alternate configurations of cutting elements, such as those disclosed in U.S. Pat. No. 5,358,197, of which the disclosure is hereby incorporated by reference into this specification, are also included within the scope of the claimed invention.

In an alternate embodiment of the device 10, the neck 14 includes only the ridge 22. In another embodiment of the invention, the neck 14 includes only the pedestal 24 with or without notches 30. In yet another embodiment, the device 10 includes a head 12 and base 16. Additional embodiments of the device 10 not disclosed herein are also included within the scope of the claimed invention.

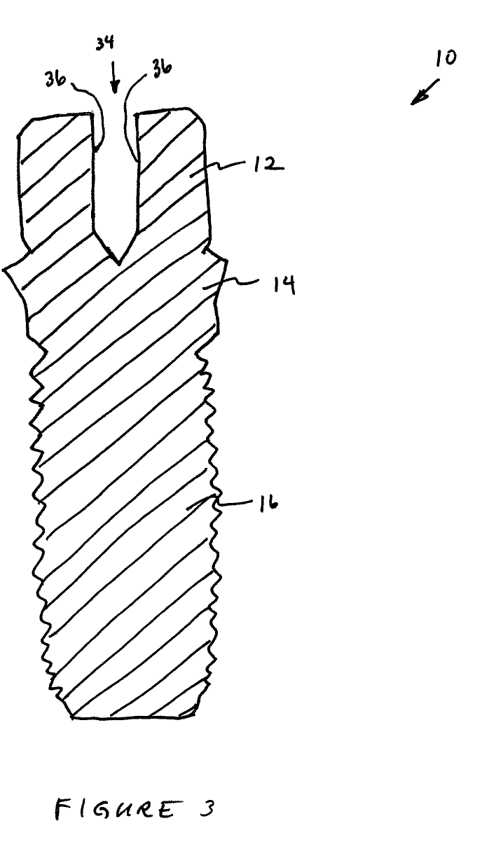

Referring to FIGS. 1A and 3, the substantially cylindrical base 16 of the universal implant-abutment device 10 includes a plurality of raised, external helical threads 32, similar to the threads of a conventional screw. In general, the configuration of the base 16 and threads 32 includes, but is not limited to, those configurations as disclosed in U.S. Pat. No. 5,338,197, U.S. Pat. No. 5,435,723, U.S. Pat. No. 5,564,924, U.S. Pat. No. 5,571,017, U.S. Pat. No. 5,601,429, U.S. Pat. No. 5,967,783 and U.S. Pat. No. 6,068,479, the disclosure of each of these patents is hereby incorporated by reference into this specification. The threads 32 serve to securely attach the base 16 of the implant-abutment device 10 within the patient's jaw. Other fastening elements including, but not limited to, barbs, retractable barbs, one-way barbs and other textured surfaces may also be used with the present invention.

The cylindrical base 16 of the device 10 may be solid or partially hollow. The structural design of the base 16 depends, in part, on the material or materials used to fabricate the device 10. For example, in one embodiment, a base 16 made of a semi-rigid material may be solid, whereas a base 16 made of a substantially rigid material may be partially hollow. Alternatively, a base 16 made of a combination of rigid and semi-rigid materials may include solid and hollow portions. Alternate configurations of the base 16 not disclosed herein are also included within the scope of the claimed invention.

Referring to FIG. 3, a substantially cylindrical, hollow core 34 extends through and along the axial length, or portions thereof, of the head 12 of the device 10. The surface of the internal walls 36 of the head 12 surrounding the core 34 may be threaded and slightly tapered. Alternative core 34 and surrounding wall/wall-surface 36 designs and configurations including smooth, dimpled, grooved, hexagonal, polygonal, tapered, stepped, arcuate and other configurations and combinations thereof, may also be used and are also included within the scope of the claimed invention. In one embodiment, the hollow core 34 is adapted to receive and securely retain a guide pin, retaining screw and/or healing ball, as described in further detail below.

In alternate embodiments (not shown), the hollow core 34 extends through and along the axial length, or portions thereof, of the head 12 and neck 14, or head 12, neck 14 and base 16. In yet another embodiment, the hollow-core 34 may be off-axis and/or non-parallel to the axial length of the device 10.

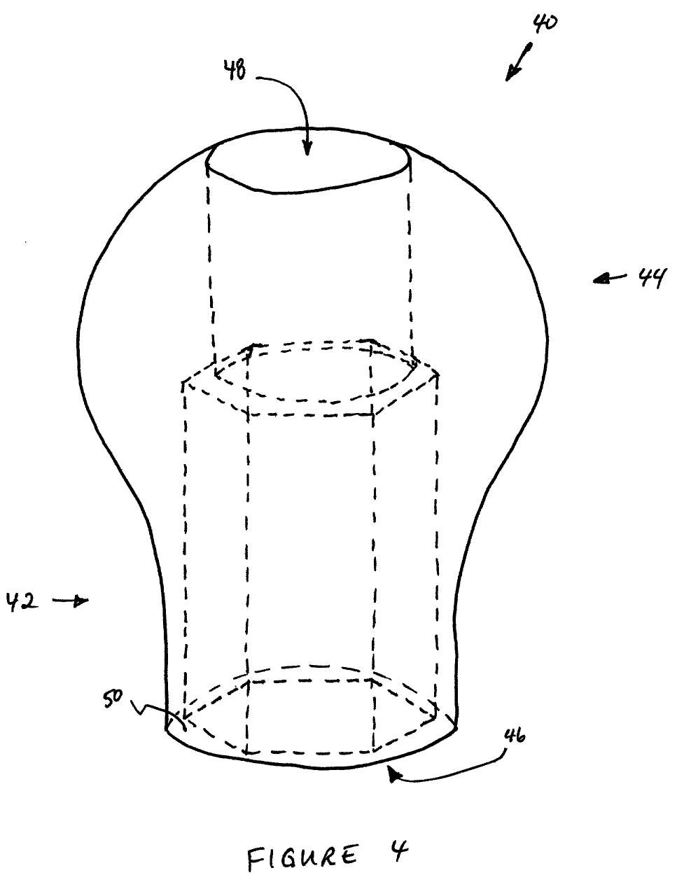

The dental implant system of the present invention may also include a healing ball 40, shown in FIG. 4, that can be either removably secured or permanently affixed to the universal implant-abutment device 10. The healing ball 40 may be made of a variety of materials and combination of materials including, but not limited to, medical grade polyethylene, high-density polyethylene, K-resin, plastics, ceramics, metals and metal-alloys. In general, the healing ball 40 may be made of any biocompatible, non-toxic (e.g., medical grade) material that permits proper functioning of the healing ball 40. In another embodiment of the invention, the healing ball material may also include barium or similar elements that make the healing ball radiopaque.

Referring to FIG. 4, the healing ball 40 includes a cylindrical lower 42 portion and a spherical upper portion 44. Other healing ball configurations including, but not limited to, tooth-shaped, cone-shaped, box-shaped, donut-shaped, collar-shaped, cylindrical and spherical may also be used with the dental implant system. In another embodiment (not shown), the healing ball 40 may include one or more small holes or recesses. These holes/recesses may function as gripping and/or anti-rotational/anti-torquing features that are engaged when tightening, removing or repositioning the healing ball within the patient's mouth.

As shown in FIG. 4, a hexagonal-shaped bore or opening 46 extends along the axial length of the lower portion 42 and partially along the corresponding axial length of the upper portion 44. The hexagonal shape of the bore 46 is used for illustration purposes and not meant to limit the invention. In general, a variety of bore shapes or configurations adapted to engage the head 12 of the implant-abutment device 10 may be used with the healing ball 40 of the present invention.

A cylindrical bore or opening 48 lies adjacent to and is aligned along the same axis of the hexagonal bore 46. The diameter of the cylindrical opening 48 may be less than, equivalent to or greater than the diameter of the hexagonal bore 46. As will be described in further detail below, the cylindrical opening 48 forms a lumen through the healing ball 40, thereby enabling associated components, such as a guide pin, retaining screw, cement, wax and other components included within the scope of the claimed invention, to be inserted therethrough. In yet another embodiment (not shown), the opening 48 may be off-axis and/or non-parallel to the axis of the device 10.

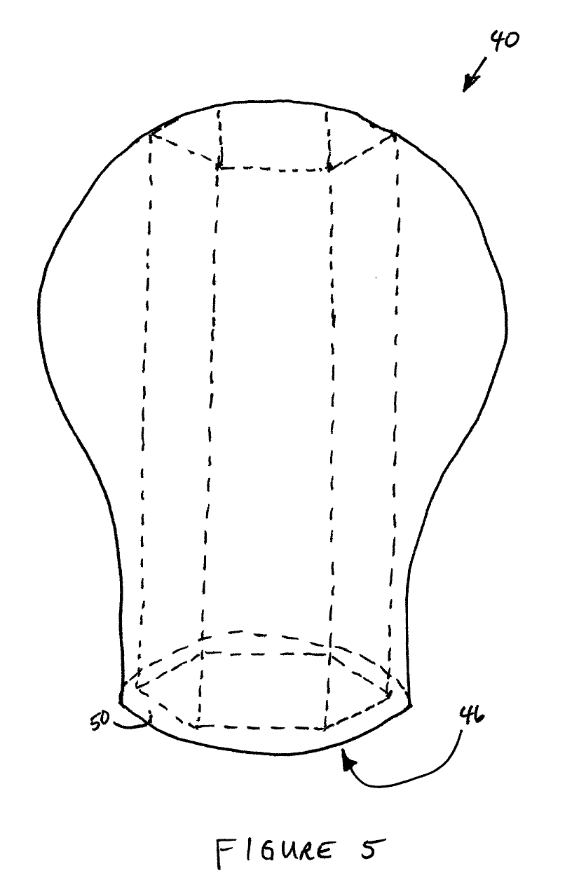

In an alternate embodiment, shown in FIG. 5, the cylindrical bore 48 is removed and the hexagonal bore 46 forms the entire opening or lumen through the healing ball 40. In another embodiment (not shown), the hexagonal bore 46 is removed and the cylindrical bore 48 forms the entire opening or lumen through the healing ball 40. For reader convenience, references to the opening 46 of the healing ball 40 for the remainder of this disclosure will be understood to include opening 46 and/or opening 48.

As previously described, the opening 46 of the healing ball 40 is configured to match and snugly fit over the hexagonal head 12 of the implant-abutment device 10. As such, an octagonal opening in a healing ball 40 would be used for a device 10 having an octagonal head 12, a triangular opening 46 in a healing ball 40 would be used for a device 10 with a triangular head 12, and so on.

In another embodiment (not shown), a reverse configuration of the manner in which the device 10 and healing ball 40 engage each other is also included in the scope of the present invention. For example, the device 10 may include a recess, bore or opening into which the healing ball's 40 mating shaft, post or protrusion is inserted. Other methods of engagement not specifically disclosed herein but known in the art are also included within the scope of the claimed invention.

In an alternate embodiment (not shown), the opening 46 is formed of two opposing flat surfaces or walls and two opposing arcuate surfaces or walls. The two flat surfaces of the healing ball 40 engage two of the main-walls 18 of the implant-abutment head 12 and the two arcuate surfaces engage the remaining main-walls 18. Thus, the healing ball 40 engages the device head 12 in a manner similar to a conventional wrench-and-socket configuration. Alternate embodiments of the opening 46 including, but not limited to, cylindrical, spherical, stepped, cylindrically-tapered, off-axis, non-parallel and other configurations not specifically disclosed herein are also included within the scope of the claimed invention.

In another embodiment of the healing ball 40, the axial length of the opening 46 is approximately equivalent to the height HY of the head 12 (shown in FIG. 1). Alternatively, the length of the opening 46 may be greater than the height HY of the head 12. In one embodiment, the base 50 of the healing ball 40 surrounding the opening 46 rests upon the ledge 26 of the device 10, ensuring a proper fit within the patient's mouth. In another embodiment (not shown), the opening of the healing ball 40 includes an inwardly-extending annular protuberance which is adapted to fit within and is removably secured to a matching annular groove surrounding the device 10. This configuration and other embodiments disclosed in U.S. Pat. No. 6,068,479 (of which the specification is incorporated herein by reference) or not specifically disclosed herein are also included within the scope of the claimed invention.

The healing ball 40 is but one of many types of dental copings which may be used with the device 10 of the present invention. Other types of dental copings and/or gold cylinders including, but not limited to, those disclosed in U.S. Pat. No. 6,068,479, U.S. Pat. No. 5,733,124, U.S. Pat. No. 5,613,854, U.S. Pat. No. 5,571,016, U.S. Pat. No. 5,476,383, U.S. Pat. No. 5,439,380, U.S. Pat. No. 5,419,702, U.S. Pat. No. 5,213,502, U.S. Pat. No. 5,209,659, U.S. Pat. No. 5,145,371, U.S. Pat. No. 5,108,288, U.S. Pat. No. 5,040,983, U.S. Pat. No. 4,861,767, U.S. Pat. No. 4,797,100, U.S. Pat. No. 4,698,021, U.S. Pat. No. 4,676,751, U.S. Pat. No. 4,492,579, U.S. Pat. No. 4,459,112, U.S. Pat. No. 3,685,114, RE 33,796, RE 33,272, RE 33,099, and the like may also be used with the implant-abutment device 10. The entire disclosure of each of these patents is hereby incorporated by reference into this specification.

In one embodiment of the present invention, the healing ball 40 may be removed from the implant-abutment device 10 prior to attachment of the dental prosthesis. As such, the healing ball 40 may serve as a temporary cover to protect the patient's tongue, inner-cheek and/or inner-lips from contacting potentially rough or abrasive edges of the device 10. In addition, the healing ball 40 may also function as a tissue spacer, as described in further detail below. Guide pins, retaining screws, wax or other attachment devices or compounds, including various combinations thereof, may be used to temporarily attach the healing ball 40 to the device 10. Once the final prosthesis is available, the attachment device or compound and healing ball 40 are removed and the prosthesis is secured to the implant-abutment device 10 within the patient's mouth.

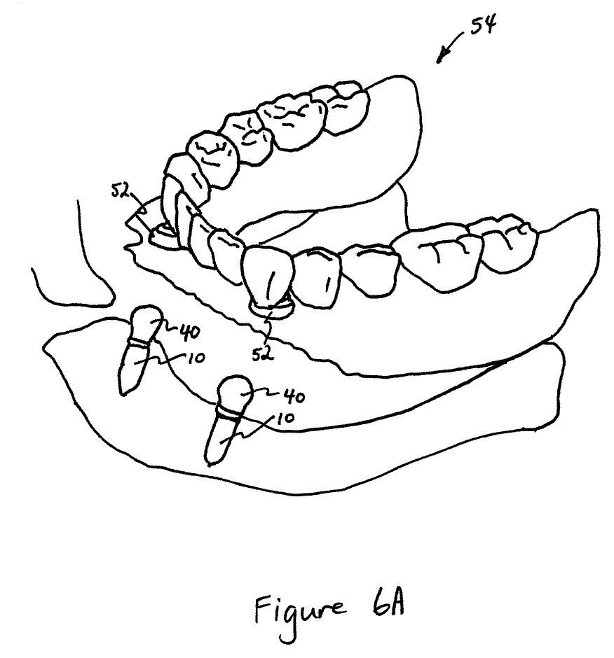

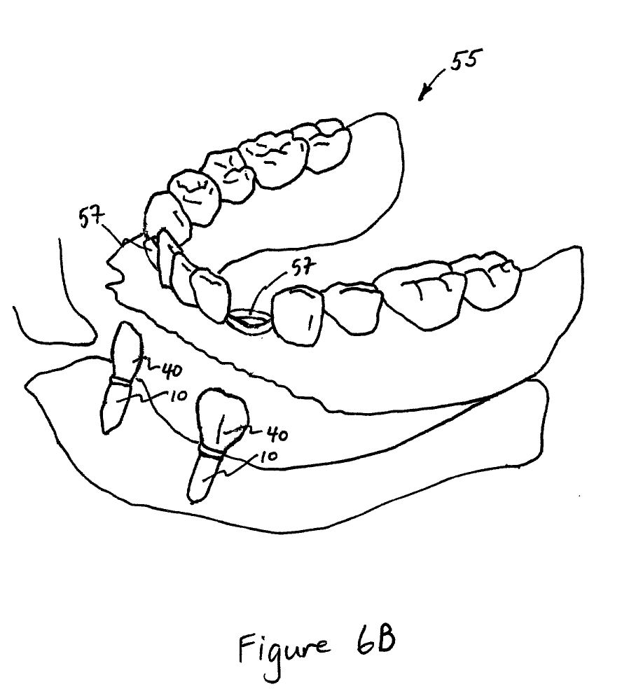

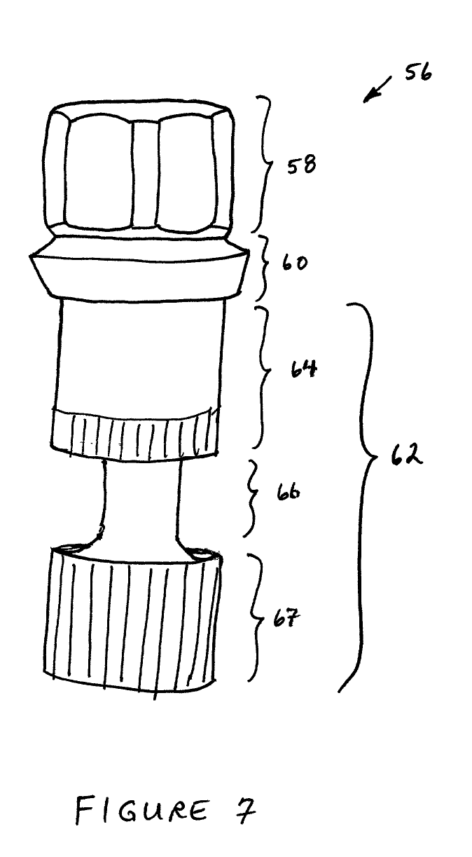

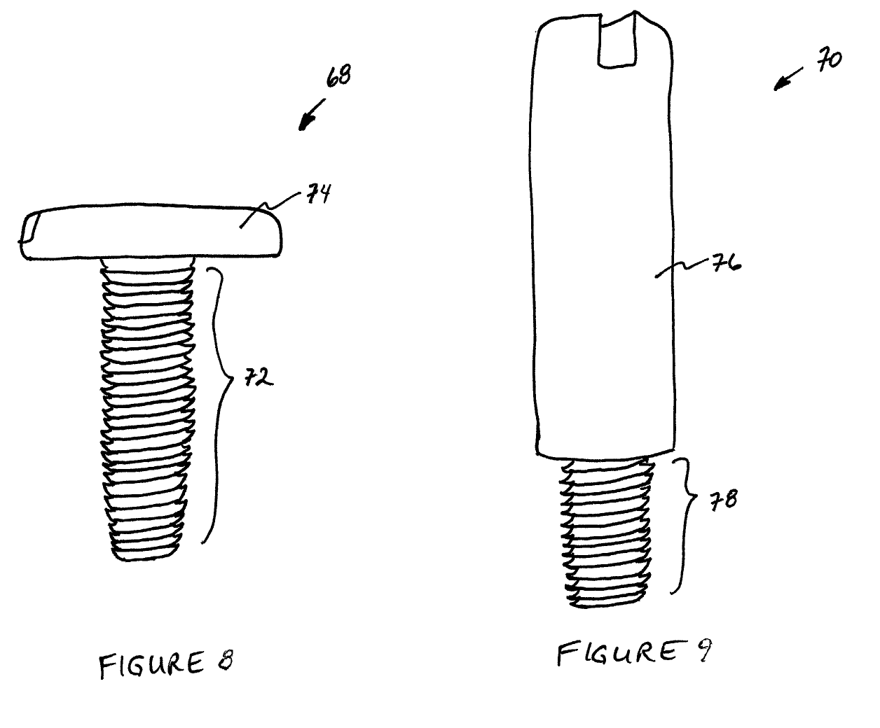

In another embodiment of the invention, the healing ball 40 may be permanently affixed to the device 10 so that the dental prosthesis directly attaches to the healing ball 40. For example, prostheses or dentures including metal rings, caps with rubber o-rings, ball attachment replicas and other similar fastening elements may be friction fit over the healing ball 40 to firmly, securely and removably attach the prosthesis to the implant-abutment device 10. As shown in FIG. 6A, one or more healing ball 40 and implant-abutment device 10 assemblies are secured within the patient's mouth. Attachment devices and compounds including, but not limited to, cement, retaining screws, glues, wax, permanent soft-liner materials (such as, for example, silicone or Coesoft®) and other attachment devices and compounds, including combinations thereof, may be used to permanently secure the healing ball 40 onto the implant-abutment device 10. The fastening elements 52 of the prosthesis 54 are then friction fit over the healing balls 40 to securely attach the prosthesis 54 within the patient's mouth.

In an alternate embodiment, one or more tooth-shaped healing balls 40 are permanently affixed to one or more devices 10 implanted within the patient's jawbone. As shown in FIG. 6B, a prosthesis, denture or partial-denture 55 including one or more retention clasps, rings or elements 57 aligned to engage the healing ball(s) 40 act as retaining elements to secure and stabilize the denture in the patient's mouth. Alternate configurations of attaching the dental implant system of the present invention either removably or permanently to a prosthesis well-known to those skilled in the art are also included within the scope of the present invention.

In another embodiment of the invention (not shown), bar-clip overdentures, crowns and/or bridges (such as those disclosed in U.S. Pat. No. 5,174,954, of which the entire disclosure is herein incorporated by reference) may be readily connected to either the healing ball 40 and implant-abutment device assemblies or to the gold-cylinder and implant-abutment device 10 assemblies. As will be apparent to those skilled in the art, the universality of the dental implant system of the present invention enables it to be used in conjunction with many different types of prosthetic applications. Further, it provides the dental practitioner with substantially more flexibility with reduced number of parts/components than the prior art systems.

Referring to FIG. 7, the dental implant system of the present invention may also include an abutment-analog 56. The abutment-analog 56 is generally a replica of the head 12 and/or neck 14 of the implant-abutment device 10 and mainly used in laboratory procedures during construction of patient models and prostheses. The abutment-analog includes a head 58 and neck 60 similar in design and configuration to the head 12 and neck 14 of the implant-abutment device 10 previously described. In one embodiment, the head 58 and neck 60 of the abutment-analog 56 are exact replicas of the head 12 and neck 14 of the implant-abutment device 10.

The analog-abutment 56 may be made from a variety of materials. Examples of such materials include, but are not limited to, brass, gold, titanium, stainless steel, metals, metal-alloys, ceramics, plastics, composites and combinations thereof are also included within the scope of the claimed invention.

As shown in FIG. 7, the abutment-analog 56 also includes a shaft 62. In one embodiment, the shaft 62 includes cylindrically shaped top 64, middle 66 and bottom 67 portions. The diameter of each shaft portion 64, 66, 67 is variable, ranging in size from approximately 1.0 mm to 10.0 mm. For example, in one embodiment the top portion 64 is approximately 3.0 mm, the middle portion 66 is approximately 1.75 mm and the bottom portion 67 is approximately 3.0 mm. Alternatively, the top 64, middle 66 and bottom 67 portions maybe approximately 1.0 mm, 3.0 mm and 1.0 mm, respectively. In general, the shaft 62 may be configured with various gripping surfaces, projections, indentations, flat/planar portions and non-planar portions to prevent the analog-abutment 56 from becoming dislodged from or rotating around the rigid stone or plaster material that forms the final model for the prosthesis, as described in further detail below.

Referring to FIGS. 8 and 9, the dental implant system of the present invention may also include a retaining screw 68 and guide pin 70, respectively. Referring to FIG. 8, the retaining screw 68 is used to secure the healing ball 40 and/or prosthesis, either permanently or temporarily, onto the implant-abutment device 10. As such, the threaded portion 72 of the retaining screw 68 is configured to engage the threads on the surface of the internal walls 36 of the device 10. In general, the retaining screw may be approximately 2.0 mm to 10.0 mm in length and is similar in design to conventional screws. In one embodiment, the diameter of the head 74 of the retaining screw 68 may be configured to seat within the lumen of the healing ball 40. Alternatively, the head 74 may be seated on the external surface of the healing ball 40. The retaining screw 68 may be made of a variety of biocompatible, non-toxic materials including, but not limited to, brass, gold, titanium, stainless steel, metals, metal-alloys, ceramics, plastics, composites and combinations thereof are also included within the scope of the claimed invention.

The guide pin 70, shown in FIG. 9, is used to secure the healing ball 40 to the implant-abutment device 10 for taking final impressions of the position of the head 12 of the device 10. The length of the guide pin 70 is approximately within the range of 3.0 mm to 20.0 mm. In general, the guide pin 70 is configured so that a sufficient portion of the head or shaft 76 extends outside of the healing ball 40, enabling a user or practitioner to firmly and securely grip the guide pin 70. The shaft 76 may be made of a variety of shapes and surface configurations including, but not limited to, cylindrical, conical, polygonal, ribbed, dimpled, smooth and textured.

As with the retaining screw 68, the threaded portion 78 of the guide pin 70 may also be configured to engage the threads on the surface of the internal walls 36 of the device 10. In addition, a variety of biocompatible, non-toxic materials may be used to fabricate the guide pin 70 of the present invention. Examples of these materials include, but are not limited to, brass, gold, titanium, stainless steel, metals, metal-alloys, ceramics, plastics, composites and combinations thereof are also included within the scope of the claimed invention.

Although the retaining screw 68 and guide pin 70 are shown in FIGS. 8 and 9, respectively, to include a slotted head, other head configurations known in the art to either manually or mechanically drive the screw 68/guide pin 70 into the device 10 may also be used and are included within the scope of the claimed invention.

One or more of the universal implant-abutment device 10, healing ball 40, abutment-analog 56, guide pin 70 and retaining screw 68 components of the dental implant system of the present invention may be packaged together to form a kit (not shown). The size, material, shape and configuration of each component compliments the other components, thereby assuring compatibility, interchangeability, durability and perfect fit. In addition, component parameters, such as size, material, shape and configuration of each component for either single or multiple tooth replacement kits, may be the same or variable within each kit.

Each kit may be configured to provide the necessary components for a particular procedure. For example, in one embodiment of the invention, the kit for a single-tooth replacement procedure may include one implant abutment device 10, three healing balls 40, one analog abutment 56, one retaining screw 68 and one guide pin 70. In another embodiment, a single-tooth replacement kit may include two implant abutment devices 10, six healing balls 40, two analog abutments 56, two retaining screws 68 and two guide pins 70. In an alternate embodiment, a multiple-tooth replacement kit may include three implant abutment devices 10, nine healing balls 40, three analog abutments 56, three retaining screws 68 and three guide pins 70. Other kit configurations not disclosed herein but known in the art are also included within the scope of the claimed invention.

### Methods of Use

Many methods of using the universal implant system of the present invention are contemplated herein. Each methodology is related to the particular type of dental reconstruction required by the patient's condition. The following methods are intended as example and for illustration purposes only and are not meant to limit the claimed invention.

### Single Tooth Reconstruction Method

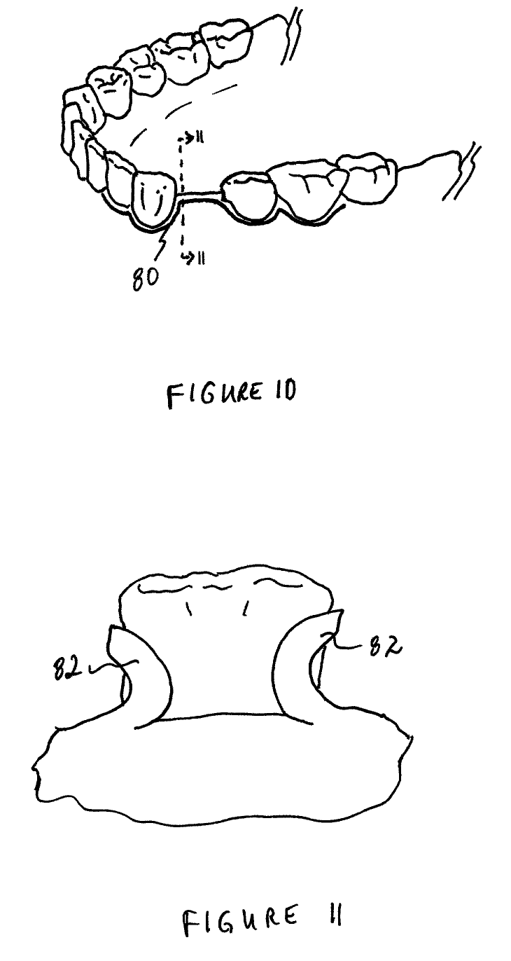

In one embodiment, a mid-crestal and reverse bevel labial incision 80 is made extending along two teeth and on both sides of the edentulous space, as shown in FIG. 10. A similar incision is made palatally, resulting in a full thickness envelope flap 82 as shown in FIG. 11.

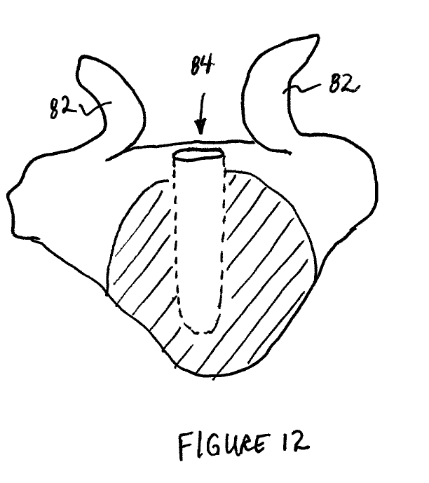

Referring to FIG. 12, a hole 84 is then drilled within the jawbone of the patient. The exact point of purchase and approach, either cingulum or labial, within the edentulous space and jaw anatomy are visually determined. In general, the approach should be one that will provide the greatest amount of stability for the device 10, and, generally, is parallel to the long axis of adjacent teeth.

One or more drill bits used at variable speeds with sufficient irrigation create the appropriately sized and shaped hole 84. The depth of the hole 84 is sized to receive the base 16 of the implant-abutment device 10, and generally ranges from approximately 8 mm to 30 mm in depth.

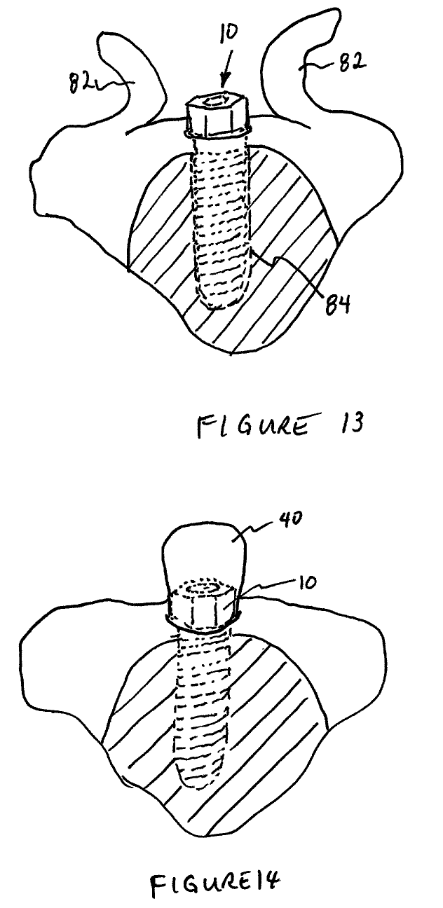

Referring to FIG. 13, the implant-abutment device 10 is then manually inserted into the hole 84 in a sterile manner. In one embodiment, a carrier (not shown) may be used to deliver the implant-abutment device 10 to the hole 84 and also to begin manually screwing the device 10 into the hole 84. An example of such a carrier is disclosed in U.S. Pat. No. 6,068,479, of which the entire disclosure in incorporated herein by reference. Other carriers and similar tools not specifically disclosure herein but known in the art may also be used and are included within the scope of the claimed invention.

Generally, only a portion of the base 16 of the implant-abutment device 10 can be manually inserted into the hole 84. A power-driven socket-wrench, contra-angle handpiece or similar tool may be used to fully seat the device 10 within the hole 84. Crestal bone height and clinical parameters such as device stability, tissue thickness as required for prosthesis aesthetics and inter-occlusal distance may also be taken into consideration to determine final position and configuration of the device 10.

The gingival tissue and flaps 82 are inspected, trimmed, coapted and sutured around the head 12 of the device 10. Factors such as amount of tissue recession after healing, final crown space required and/or other aesthetic and prosthetic considerations may be taken into account with respect to tissue placement and suturing.

Either immediately after suturing or anytime thereafter, the prosthesis may be attached to the device 10. No further surgical procedures are required, unlike prior art processes which often require a second stage surgery to expose and prepare a gingival seat around the device and perform other modifications to ensure proper prosthetic-device engagement. As previously described, with prior art devices and procedures, a space or recess between the device and soft tissue must be created to allow an appropriate interface and ensure proper placement of the prosthesis without trapping soft tissue. In contrast, the prosthesis may be directly attached to the implant-abutment device 10 of the present invention without further surgical intervention.

Referring to FIG. 14, a healing ball 40 may be attached to the device 10 to contour the tissue for proper impression registration. In one embodiment of the invention, the healing ball 40 is attached directly after tissue suturing and prior to hard and soft tissue healing. A retaining screw 68 or similar component previously described may be used to secure the healing ball 40 onto the device 10. The healing ball 40 is then left in place for an approximately seven to ten day time period. Alternate time periods that allow the soft tissue to mature and form a stable recess for the prosthesis may also be used.

After the soft tissue has matured and formed a stable recess, a final impression may be taken from which the prosthesis is created. The original healing ball 40 is removed and another, interchangeable healing ball 40 is secured to the device 10 with a guide pin 70. Alternatively, the original healing ball 40 is left in place and the retaining screw 68 is replaced with a guide pin 70.

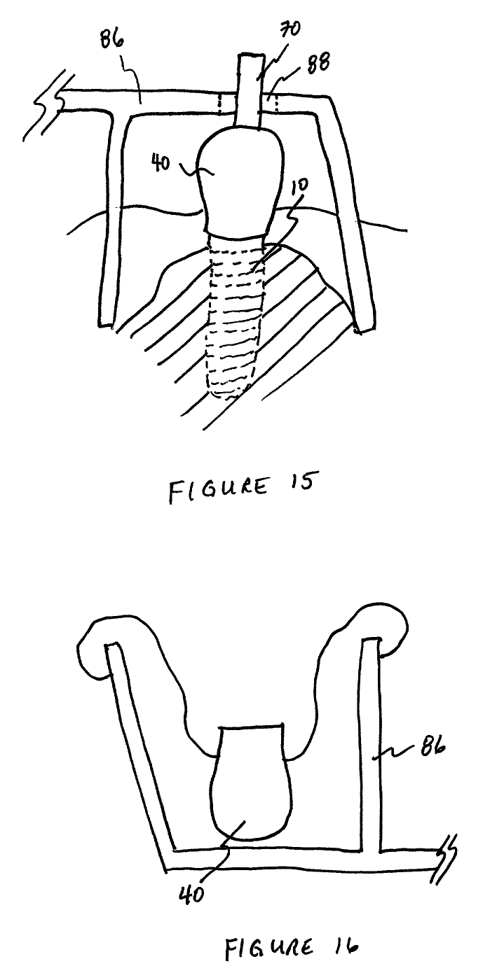

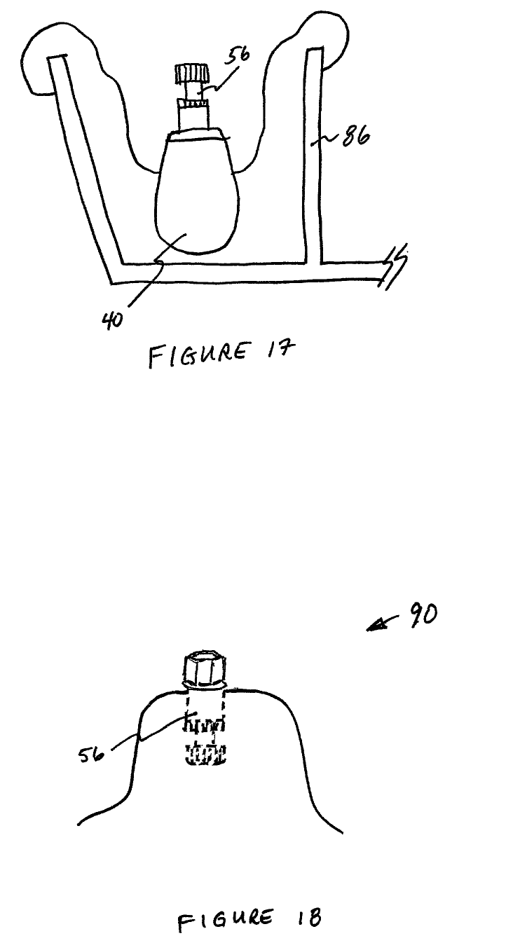

As shown in FIG. 15, an impression tray 86 with a window or opening 88 is placed over the healing ball 40 within the patient's mouth. The opening 88 of the tray 86 is aligned with the guide pin 70 so that the guide pin 70 protrudes above the impression frame. The guide pin 70 holds the healing ball 40 in place during setting of the impression material. After the material is set, the protruding portion of the guide pin 70 is used to unscrew the guide pin 70 from the healing ball 40 and remove the guide pin 70 through the tray opening 88. The healing ball 40 is then transferred with the impression material when the impression tray 86 is removed from the patient's mouth, as shown in FIG. 16. The original healing ball 40 may be re-attached to the device 10 as a protective covering and tissue spacer.

In an alternate embodiment, anti-rotational grooves, indentations or other types of gripping features may be formed on the healing ball 40. These features prevent movement or displacement of the healing ball 40 within the impression material when the healing ball/impression tray are removed from the patient's mouth.

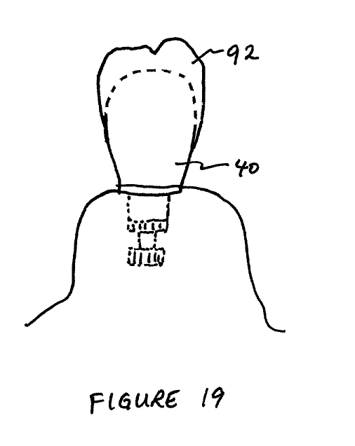

Referring to FIG. 17, an analog-abutment 56 is inserted into the matching cavity of the healing ball 40 contained within the impression material. As previously described, the analog-abutment 56 replicates the configuration of the implant-abutment device 10 of the present invention. With the analog-abutment 56 seated in the healing ball 40, an impression is then poured in a rigid stone or plaster material to form the final model 90. In general, the entire analog-abutment 56, excluding its head 58 or head 58 and neck 60, may be buried in the final working model 90. As such, the remaining exposed portion of the analog-abutment 56, together with the impression material, forms an accurate and visible replica of the edentulous space within the patient's mouth prior to restoration, as shown in FIG. 18.

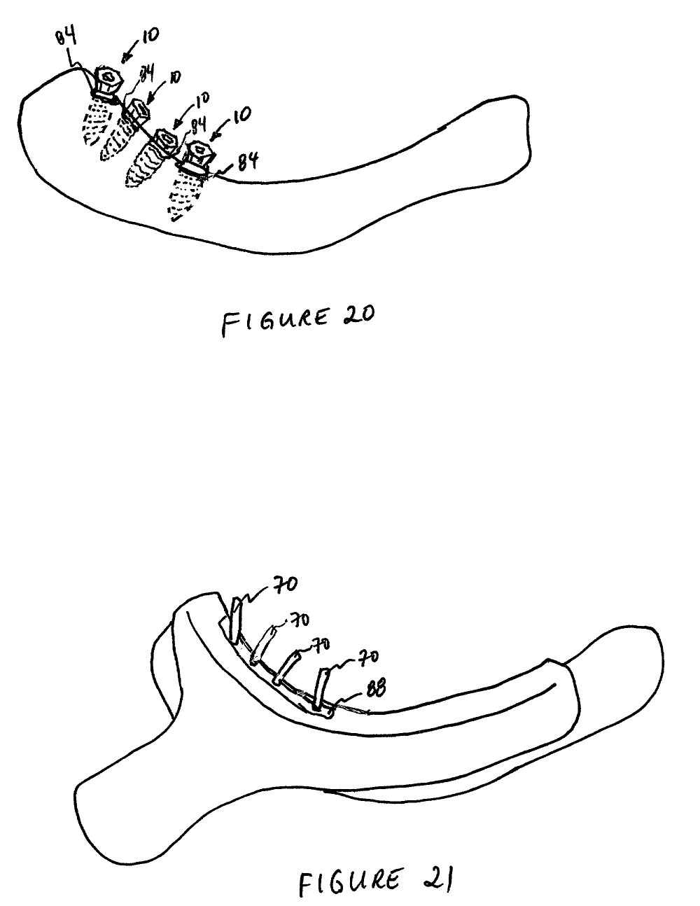

Referring to FIG. 19, a healing ball 40, coping (such as a preformed coping in the shape of a healing ball 40, tooth or other shapes) or metal framework may be used as part of the final prosthesis 92. Some of the materials used to form the final prosthesis include, but are not limited to, metal, metal alloys, ceramics, composites, alumina oxide, fiber core, zirconium and other materials. The final prosthesis 92 may be formed using a lost wax technique, laser scan generated images, optical impression, CAD/CAM manufacturing, reverse engineering, rapid prototyping and other conventional techniques or methods. Once complete, the final prosthesis 92 is then installed within the patient's mouth using cement, retaining screws or other attachment means known to those skilled in the art and included within the scope of the claimed invention.

In an alternate embodiment (not shown), two or more implant-abutment devices 10 may be used for a single tooth (e.g., molar) restoration. The use of multiple implant-abutment devices 10 for a single tooth restoration provides greater support and stability for the final prosthesis. In addition, this configuration provides improved osseointegration and greater device surface area, which also improves the retentive strength of the prosthesis.

### Multiple Tooth or Full-Mouth Reconstruction Method

A multiple tooth or full-mouth reconstruction method of the present invention is similar to the single tooth reconstruction method. However, as previously described, multiple tooth or full-mouth reconstruction procedures are more involved, requiring common paths of insertion, sufficient friction to ensure a firm fit and no undue soft-tissue tension.

In one embodiment, the incision 80, hole 84 and implant-abutment device 10 insertion are made in a manner similar to that previously described for the single tooth reconstruction method. However, the approach is modified to accommodate multiple restorations. For example, the incision 80 may be larger, multiple holes 84 are generally created within the jawbone of the patient and, likewise, multiple implant-abutment devices 10 are inserted within the holes 84, as generally shown in FIG. 20. The four-teeth reconstruction shown in FIG. 20 is for illustration purposes and not meant to limit the scope of the claimed invention.

After adequate soft tissue healing has occurred and a stable recess for the prosthesis has been formed using healing balls 40 as previously described, the temporary prosthesis or original healing balls 40 are removed from each device 10. New healing balls 40 are then secured to each device 10 using guide pins 70. In one embodiment, a pattern resin or similar material may be used to lute or connect all the healing balls 40 together as one unit, forming a coping framework. This process may be used for both the original healing balls 40 and the new healing balls 40.

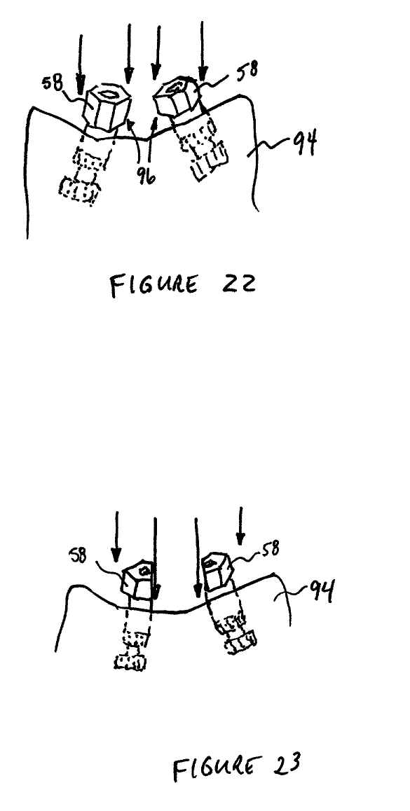

Next, an impression is taken using an appropriately sized impression tray 86. The protruding portions of the guide pins 70 extend through the opening(s) 88 in the impression framework, as shown in FIG. 21. Alternatively, a traditional disposable stock tray (not shown) may be used. As such, after all the healing balls 40 are luted or splinted together thereby forming a “picket-fence” type effect, the guide pins 70 can be removed from the healing balls 40. The healing balls 40 will remain in position and form a stable framework due to the “picket-fence” effect and remain in proper alignment with each other. Impression material can then be injected under and around the healing balls 40.

After the impression material has set, the guide pins 70, tray 86 and impression material are removed from the patient's mouth. The resulting impression includes the healing balls 40 incorporated in the impression material. The low height or minimal profile of the head 12 of each device 10 and flexibility of the impression media allow an accurate impression to be made, without permanent distortion or damage. In particular, the healing balls 40, as integral parts of the impression, may be cleanly withdrawn from the devices 10 without disturbing the precise relationship of each healing ball 40 to one another and to any adjacent teeth. Because each healing ball 40 is a replica of each device head 12, and the healing balls 40 and devices 10 are configured to accommodate a three-dimensional spatial relationship, a perfect fit of the final prosthesis to the dental implant system is virtually assured.

The head 58 or head 58 and neck 60 of each analog-abutment 56 is then placed in each healing ball cavity of the impression. With an analog-abutment 56 seated in each healing ball 40, an impression is then poured in a rigid stone or plaster material to form the final model. The final model is an exact replica and accurately presents the heads 58 of the analog-abutments 56 in the same position/alignment as the heads 12 of the implant-abutment devices 10 inserted within the patient's jawbone.

The angle of each head 58 on the stone model is analyzed to determine any undercut that may require modification in order to allow a common path of insertion. A guide pin 70 may be used to accentuate the angle of the head 58. Alternatively, the coping framework formed of the original healing balls 40 luted together (as previously described) may be placed on the stone model. The sides of the heads 58 that need to be modified (e.g., trimmed, removed) in order to seat the coping framework on the model will become readily apparent.

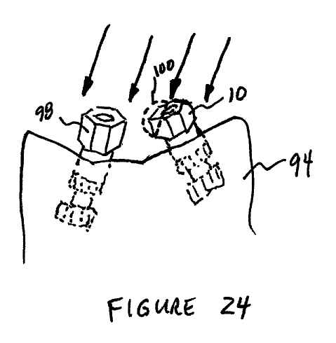

For example, as shown in FIG. 22, two of the analog-abutment heads 58 in the stone model 94 (and, thereby, the corresponding two implant-abutment device heads 12 in the patient, not shown) converge at approximately thirty-degrees. As such, the common path of insertion (illustrated by arrows) is obstructed mainly by the inner walls of the head 58. In general, the outer walls of the head 58 are not a problem. To create a common insertion path, the inner walls 96 of the converging heads 58 are removed using a burr or other tool well known in art. A maximum of three surfaces on each of the analog-abutment heads 58 may be removed and still ensure proper functioning of the dental implant system of the present invention. Alternatively, one wall or a portion of one or more walls may also be modified and still ensure proper system functioning.

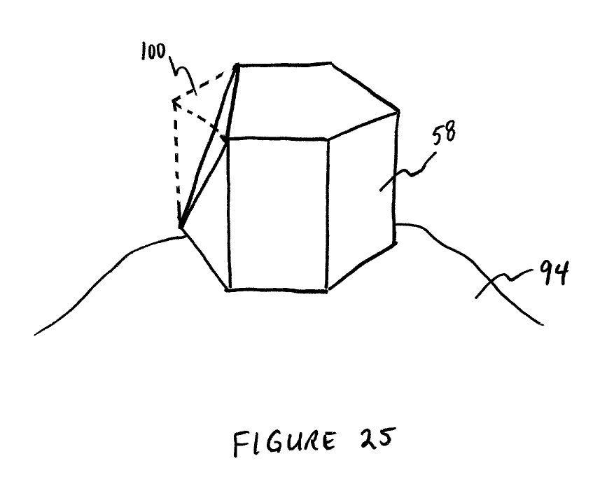

After removal of the inner walls 96, a common path of insertion is established. Referring to FIG. 23, the remaining, unmodified outer walls of each head 58 maintain an approximate half “perfect-hex” which ensures a secure, telescopic fit for the final prosthesis.

In an alternate embodiment, shown in FIG. 24, one of the devices 10 may be selected as a reference device 98. As such, no modifications are performed to this device 98. The other devices 10 are then modified (e.g. portion 100, shown in the FIG. 24 as encircled by a dashed line, is removed) according to the inclination/alignment of these devices 10 in relationship to the reference device 98 to ensure a secure and accurate fit for the final prosthesis.

Healing balls 40, copings or metal frameworks are then installed on the modified heads 58 of the stone model 94 and may be used as part of the final prosthesis. As previously described, the final prosthesis may be formed using a lost wax technique, laser scan generated images, optical impression, CAD/CAM manufacturing, reverse engineering, rapid prototyping and other conventional techniques or methods.

With the final stone model 94 as a guide, the corresponding surfaces of the device heads 12 in the patient's mouth are removed. After a passive placement is achieved, the final prosthesis is then installed using cement, retaining screws or other attachment means to stabilize and secure the prosthesis within the patient's mouth.

In an alternate embodiment of the invention, a template (not shown) together with the final stone model 94 is used as a guide for removing the necessary portions/surfaces of the device heads 12 in the patient's mouth. The template may be one or more copings, caps, framework or other types of coverings linked or connected together to maintain alignment of the caps to each other and to their counter-part analog-abutments 56 in the final stone model 94. The template may be made of a variety of materials including, but not limited to, metals, metal alloys, plastics, ceramics, composites and other materials, including combinations of materials. Further, each cap may be a variety of configurations (such as, for example, cylindrical, spherical, hexagonal, polygonal and other configurations), provided the cap configuration matches to securely engage its corresponding analog-abutment configuration.

The following example and associated figures will reference only a single cap in a template and a single analog-abutment 56 in a final model 94, however it is understood that the template and final model 94 include one or more caps and analog-abutments 56, respectively.

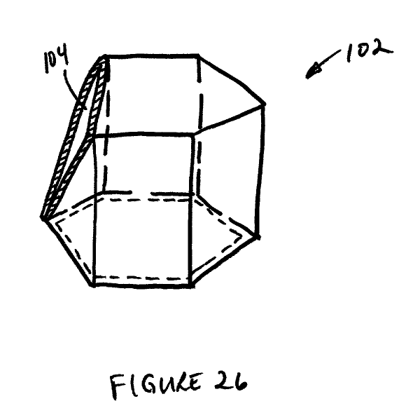

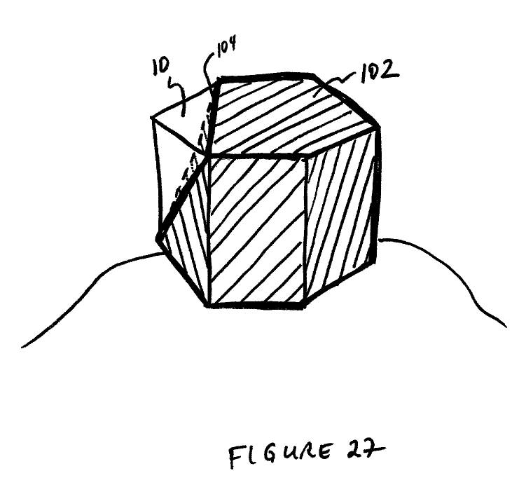

As previously disclosed, the cap of the template replicates its counterpart head 58 of the analog-abutment 56 in the final model 94. Referring to FIG. 25, a portion 100 (shown in phantom on FIG. 25) of the analog-abutment head 58 in the final model 94 is removed or modified as previously described. The corresponding portions of its matching cap 104 are then also removed, forming a window or some other type of opening 104 in the cap 102 that corresponds to the modified area of the head 58, shown in FIG. 26.

As shown in FIG. 27, when the cap 102 is properly positioned or placed over the patient's corresponding implant-abutment device 10, portions of the device 10 protruding through the opening 104 correspond to the removed portions of the analog-abutment 100. At this point, the user may use an appropriate tool to remove the protruding portions of the device 10. Alternatively, the user may simply mark the portions of the device 10 that need to be modified, remove the cap and then remove/modify the marked portions of the device 10. Other methods of modifying the device 10, including the cap 102, not specifically disclosed but known in the art may also be used.

The quantity of components and associated reconstruction methods of the dental implant system of the present invention are greatly reduced and simplified compared to conventional implant systems and methods of use. Especially in multiple implant situations, the dental implant system of the present invention greatly reduces the number of clinical procedures and total treatment time. In particular, the amount of time between the initial surgery to the tooth/prosthesis mounting is greatly reduced.

Further, the procedures or methods of the present invention are also more predictable with respect to cosmetic and functional effects of the final prosthesis when compared to traditional approaches. As such, the dental implant system of the present invention may reduce post-operative infection, improve device/prosthesis strength and prolong its stability and reduce the overall time for a reconstruction procedure by approximately three months or more. In addition, the dental implant system and associated methods of the present invention enable a practitioner to form a final prosthesis, including an infinite number of facsimiles of said final prosthesis (for example, as spares or replacements if the original prosthesis should become damaged or lost), based on a single impression. In general, the overall procedure using the dental implant system of the present invention is fast, simple and effective.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A method of dental reconstruction comprising:
inserting one or more devices into an edentulous space within a patient's mouth, wherein each of said devices includes a head portion;
placing a healing ball on each of said heads of said devices;
forming a dental impression with impression material, wherein said healing balls transfer with said impression material upon removal from a patient's mouth;
mounting an analog-abutment within each of said healing balls of said impression;
forming a final model of said dental impression including said analog abutments, said final model replicating said patient's edentulous space;
creating a final prosthesis using said final model; and
installing said final prosthesis within said edentulous space of said patient.

2. The method of claim 1 further comprising placing a healing ball on each of said analog-abutments of said final model.

3. The method of claim 1 further comprising forming a framework on said final model.

4. The method of claim 1 further comprising modifying one or more heads of said devices.

5. The method of claim 1 further forming a stable recess in tissue surrounding each of said devices using said healing balls.

6. The method of claim 1 further comprising placing an impression tray over said one or more healing balls.

7. The method of claim 1 further comprising securing said one or more healing balls to said devices using a retaining screw.

8. The method of claim 1 further comprising securing said one or more healing balls to said devices using a guide pin.

9. The method of claim 1 further comprising removing one or more original healing balls and securing one or more interchangeable healing balls onto said one or more devices.

10. The method of claim 1 further comprising forming anti-rotational grooves on said one or more healing balls.

11. The method of claim 1 further comprising connecting said healing balls together to form a coping framework.

12. The method of claim 1 further comprising establishing a common path of insertion on said final model;

13. The method of claim 12 further comprising establishing a common path of insertion on said devices in said edentulous space of said patient's mouth.

14. A universal dental implant system comprising:
a head portion; and
a base portion, wherein said base portion includes fastening elements to secure said implant within a jawbone of a patient.

15. The universal dental implant system of claim 14 further including a neck portion.

16. The universal dental implant system of claim 14 wherein said head portion is hexagonal in shape.

17. The universal dental implant system of claim 14 further comprising a healing ball, wherein said healing ball mounts onto said head portion.

18. The universal dental implant system of claim 17 further comprising a retaining screw, wherein said retaining screw secures said healing ball onto said head portion.

19. The universal dental implant system of claim 17 further comprising a guide pin, wherein said guide pin secures said healing ball onto said head portion.

20. The universal dental implant system of claim 17 wherein said healing ball is tooth-shaped.

21. A method of forming a dental prosthetic comprising:
fixing a stud element in a predetermined site;
placing a removable protective element on said stud element;
forming a first impression over said protective element at said predetermined site;
removing said protective element from said stud element with said first impression;
mounting an abutment in said protective element contained in said first impression;
forming a second impression over said abutment such that said second impression substantially replicates said predetermined site; and,
creating a prosthesis by relying on information provided by said second impression.

22. A method of forming a dental prosthetic comprising:
providing a first impression which replicates a dental site;
inserting a fixation element into said first impression;
providing a second impression which replicates said dental site and retains said fixation element; and,
modifying said fixation element on said second impression as needed so as to provide sufficient information to create said prosthetic.

23. A model for creating a dental prosthetic comprising:
a form replicating the region of an edentulous space within a patient's mouth;
said form having an analog abutment protruding from said region; and,
said analog abutment having a modification created to ensure insertability and removability of a prosthetic within a patient's mouth.
